(19) United States
(12) Patent Application Publication
(10) Pub. No.: US 2011/0120928 A1
(43) Pub. Date: May 26, 2011

(54) EASY CHANGE FILTER ASSEMBLY FOR REVERSE OSMOSIS MEMBRANE WATER PURIFICATION SYSTEM

(75) Inventor: Craig A. Schmitt, Phoenix, AZ (US)

(73) Assignee: WATTS WATER TECHNOLOGIES, INC., North Andover, MA (US)

(21) Appl. No.: 12/952,547

(22) Filed: Nov. 23, 2010

Related U.S. Application Data
(60) Provisional application No. 61/264,485, filed on Nov. 25, 2009.

(51) Int. Cl. C02F 1/44; B01D 63/00

(52) U.S. Cl. 210/232

(57) ABSTRACT

A filter head including a lid extending along a central axis. The lid includes a filter bowl receptacle positioned coaxially about the central axis, a central receptacle positioned coaxially within the filter bowl receptacle, and an intermediate receptacle positioned coaxially between the central receptacle and the filter bowl receptacle. A conduit portion connects to the lid and extends along another axis that is normal to the central axis of the lid. The conduit portion includes a first pathway extending between the first end and the filter bowl receptacle, a second pathway extending between the first end and the central receptacle, a third pathway extending between the second end and the central receptacle, and a fourth pathway extending between the second end and the intermediate receptacle. Couplings allow the filter head to be pivoted about the central axis of the conduit portion.

### CROSS-REFERENCE TO RELATED APPLICATION

This application claims priority to U.S. Provisional Patent Application No. 61/264,485 filed Nov. 25, 2009, which is incorporated herein by reference.

### TECHNICAL FIELD OF THE DISCLOSURE

The present disclosure relates to reverse osmosis water filtering systems and, more particularly, to an improved filter manifold or head.

### BACKGROUND OF THE DISCLOSURE

As is known, a reverse osmosis (RO) water filtering process uses a semi-permeable membrane that has the ability to remove and reject a wide spectrum of impurities and contaminants from water using only water pressure. These contaminants are automatically rinsed down the drain as concentrate. The purified water or permeate is then stored in a tank for dispensing through a faucet.

In many applications, the RO water filtering system includes additional filters connected in series. For residential applications, the RO water filtering system may be installed under a kitchen sink. In commercial applications, the RO water filtering system may be installed in a fountain machine with even more difficult space constraints than in the home.

A typical RO filtering system includes a filter assembly, a reverse osmosis membrane, a storage tank, and an auxiliary faucet attached to the sink. The filter assembly includes a sediment filter and a carbon filter. Intake water enters the system from a cold-water source and is routed through the filter system. The sediment filter removes sediment such as sand and dirt and the like from the intake water, while the carbon filter removes chlorine and other contaminants that cause bad color, odor and taste. The filtered water is then routed to the RO membrane. All of these components need to be efficiently packaged.

### SUMMARY OF THE DISCLOSURE

The present disclosure provides a new and improved RO water filtering system. Among other aspects and advantages, the RO water filtering system of the present disclosure includes a filter head with an improved ability to replace the filters.

The present disclosure also provides a filter head including a lid extending along a central axis. The lid includes a filter bowl receptacle positioned coaxially about the central axis, a central receptacle positioned coaxially within the filter bowl receptacle, and an intermediate receptacle positioned coaxially between the central receptacle and the filter bowl receptacle. A conduit portion connects to the lid and extends between a first end and a second end along a central axis that is normal to the central axis of the lid. The conduit portion includes a first pathway extending between the first end and the filter bowl receptacle, a second pathway extending between the first end and the central receptacle, a third pathway extending between the second end and the central receptacle, and a fourth pathway extending between the second end and the intermediate receptacle. The first and second ends of the conduit portion are adapted to receive couplings such that the filter head can be pivoted about the axis of the conduit portion.

According to one exemplary embodiment, the second and the fourth pathways are aligned with the axis of the conduit portion, the first pathway is positioned coaxially about the second pathway, and the third pathway is positioned coaxially about the fourth pathway. Also, the first and second ends include an inner socket aligned with the axis of the conduit portion and connected to the second and fourth pathways respectively, and an outer socket positioned coaxially about the inner socket and connected to the first and third pathways respectively.

Another embodiment of the subject technology is directed to an elongated mounting assembly for a liquid filter system including a first end connector defining a first pathway in fluid communication with a storage tank outlet for connection to a storage tank and a second pathway in fluid communication with an inlet for connection to a water source. A second end connector defines a first pathway in fluid communication with a drain outlet for waste and a second end connector defining a second pathway in fluid communication with an outlet for connection to a faucet assembly. A connector portion extends between the end connectors and a RO filter assembly creates permeate and concentrate water. The RO filter assembly depends from the connector portion. The RO filter assembly has a bowl that defines an interior having an inlet area, an intermediate area, and an outlet area and a RO filter within the interior between the inlet area and the outlet area. The connector portion has a first side defining a first pathway in fluid communication with the first pathway of the first end connector and the outlet area of the interior so that permeate may flow there through. A second pathway of the connector portion is in fluid communication with the second pathway of the first end connector and the inlet area of the interior. A second side of the connector portion defines a first flowpath in fluid communication with the first pathway of the second end connector and the intermediate area for receiving concentrate and a second pathway in fluid communication with the second pathway of the second end connector and the outlet area of the RO filter so that permeate may flow there through. Each end connector has body defining a female socket having a first tubular portion that forms the first pathway and a second tubular portion that forms the second pathway. Each side of the connector portion has a body defining a male socket having a first tubular portion that forms the first pathway and a second tubular portion that forms the second pathway.

In the elongated mounting assembly, the first end connector's female socket couples with the first side's male socket and the second end connector's female socket couples with the second side's male socket in fluid tight manners while allowing rotation of the RO filter assembly.

In one embodiment of the elongated mounting, the body of the end connectors surrounding the tubular portions has a varying inner radius such that a shoulder is also formed thereon, wherein the first tubular portion is radially within the second tubular portion. The body of the connector portion may form a flange on each side that surrounds the second tubular portion and the first tubular portion is radially inside the second tubular portion.

In still another embodiment of the elongated mounting, each tubular portion is necked down to form a shoulder and each tubular portion has ends with relatively larger inner radii such that the necked down shoulders and larger inner radii couple to form annular cavities in which at least one seal resides. The elongated mounting assembly may further include at least one additional connector portion coupled to one of the end connectors and at least one additional non-RO filter assembly having a bowl that defines an interior having an inlet area and an outlet area and a non-RO filter within the interior between the inlet area and the outlet area.

The at least one additional connector portion in the elongated mounting assembly has: (i) a first side defining a first pathway and a second pathway in fluid communication with the outlet area of the non-RO filter assembly's interior; and (ii) a second side defining a first flowpath in fluid communication with the first pathway of the at least one additional connector portion's first side and the inlet area of the non-RO filter assembly's interior, and each side of the at least one additional connector portion has a male socket including a body having a first tubular portion that forms the first pathway and a second tubular portion that forms the second pathway, each tubular portion having ends with relatively larger inner radii, and further comprising at least one retaining connector having a locking feature for engaging a mounting bracket and for coupling the connector portions together and such that the connector portions may selectively rotate about an axial axis to facilitate bowl removal and filter replacement, wherein the at least one retaining connector portion has: (i) a first side defining a first pathway and a second pathway; and (ii) a second side defining a first pathway in fluid communication with the first pathway of the at least one retaining connector portion's first side, and a second pathway in fluid communication with the second pathway of the at least one retaining connector portion's first side.

In one embodiment, the elongated mounting assembly further includes at least one retaining clip to secure the male and female sockets together. The at least one retaining connector may include a shut-off valve assembly in fluid communication with the first pathway thereof.

Preferably, when the male socket is inserted in the female socket, the flange abuts the first end connector shoulder, the respective first tubular portions and second tubular portions are aligned to complete the fluid pathways there through, and a retainer clip is inserted in a slot formed in the end connector to apply a compressive force so that the male socket is firmly and securely seated within the female socket and fluid tight seals are created and maintained even though the connector portion may be rotated upwards about the axis with respect to the first end connector.

The elongated mounting assembly may further include a third connector portion with a non-RO filter assembly and a second retaining connector coupling together connector portions. The mounting assembly may include a bracket with mounting holes, the bracket has an upper bar opposing four mounting portions for coupling with locking features on the end connectors and retaining connectors. The end connectors may have a locking feature to snap fit onto a bracket of the mounting assembly.

### BRIEF DESCRIPTION OF DRAWINGS

Reference is made to the attached drawings, wherein elements having the same reference character designations represent like elements throughout.

FIG. 1 is a front perspective view of a reverse osmosis filter system in accordance with the subject disclosure.

FIG. 2 is a back perspective view of the reverse osmosis filter system of FIG. 1.

FIG. 3 is a front view of the reverse osmosis filter system of FIG. 1.

FIG. 4 is a back view of the reverse osmosis filter system of FIG. 1.

FIG. 5 is an end view of the reverse osmosis filter system of FIG. 1.

FIG. 6 is a cross-sectional view of the filter head of the reverse osmosis filter system of FIG. 1.

FIG. 6A is a partial, enlarged view of the cross-sectional view of FIG. 6.

FIG. 7 is a perspective cross-sectional view of the filter head of the reverse osmosis filter system of FIG. 1.

FIG. 8 is an exploded view of the reverse osmosis filter system of FIG. 1.

FIG. 9 is an end view of the mounting bracket of the filter head of FIG. 1.

FIG. 10 is a front view of the mounting bracket of the filter head of FIG. 1.

FIG. 11 is a rear perspective view of the mounting bracket of the filter head of FIG. 1.

FIG. 12 is a front perspective view of the mounting bracket of the filter head of FIG. 1.

FIG. 13 is a plan front view of an end connector of the reverse osmosis filter system of FIG. 1.

FIG. 14 is a plan end view of an end connector of the reverse osmosis filter system of FIG. 1.

FIG. 15 is a perspective inner view of an end connector of the reverse osmosis filter system of FIG. 1.

FIG. 16 is a perspective end view of an end connector of the reverse osmosis filter system of FIG. 1.

FIG. 17 is a cross-sectional view of an end connector of the reverse osmosis filter system of FIG. 1.

FIG. 18 is a plan front view of a second retaining connector of the reverse osmosis filter system of FIG. 1.

FIG. 19 is a plan end view of a second retaining connector of the reverse osmosis filter system of FIG. 1.

FIG. 20 is a lower perspective view of a second retaining connector of the reverse osmosis filter system of FIG. 1.

FIG. 21 is an upper perspective end view of a second retaining connector of the reverse osmosis filter system of FIG. 1.

FIG. 22 is a cross-sectional view of a second retaining connector of the reverse osmosis filter system of FIG. 1.

FIG. 23 is a plan front view of a first retaining connector of the reverse osmosis filter system of FIG. 1.

FIG. 24 is a plan end view of a first retaining connector of the reverse osmosis filter system of FIG. 1.

FIG. 25 is a lower perspective view of a first retaining connector of the reverse osmosis filter system of FIG. 1.

FIG. 26 is an upper perspective end view of a first retaining connector of the reverse osmosis filter system of FIG. 1.

FIG. 27 is a cross-sectional view of a first retaining connector of the reverse osmosis filter system of FIG. 1.

FIG. 28 is an exploded view of a shut-off valve integral with the first retaining connector of the reverse osmosis filter system of FIG. 1.

FIG. 29 is a plan end view of a connector portion of the reverse osmosis filter system of FIG. 1.

FIG. 30 is a plan front view of a connector portion of the reverse osmosis filter system of FIG. 1.

FIG. 31 is an upper perspective end view of a connector portion of the reverse osmosis filter system of FIG. 1.

FIG. 32 is a lower perspective end view of a connector portion of the reverse osmosis filter system of FIG. 1.

FIG. 33 is a cross-sectional view of a connector portion of the reverse osmosis filter system of FIG. 1.

FIG. 34 is another cross-sectional view of the central connector portion of the reverse osmosis filter system of FIG. 1.

FIG. 35 is a perspective view of a retainer clip for use in the reverse osmosis filter system of FIG. 1.

### DETAILED DESCRIPTION OF EXEMPLARY EMBODIMENTS

The present invention overcomes many of the prior art problems associated with filter heads for such systems as reverse osmosis (RO) filtering systems. The advantages, and other features of the filter heads and RO water filter system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

Additionally, the illustrated and described embodiments can be understood as providing exemplary features of varying detail of certain embodiments, and therefore, features, components, modules, elements, and/or aspects of the illustrations can be otherwise combined, reduced, interconnected, sequenced, separated, interchanged, positioned, and/or rearranged without materially departing from the disclosed systems or methods. Further, the shapes and sizes of components are also for exemplary purposes and can be altered without materially affecting or limiting the disclosed technology. For clarity, some common items such as tubing have not been specifically included as would be appreciated by those of ordinary skill in the pertinent art.

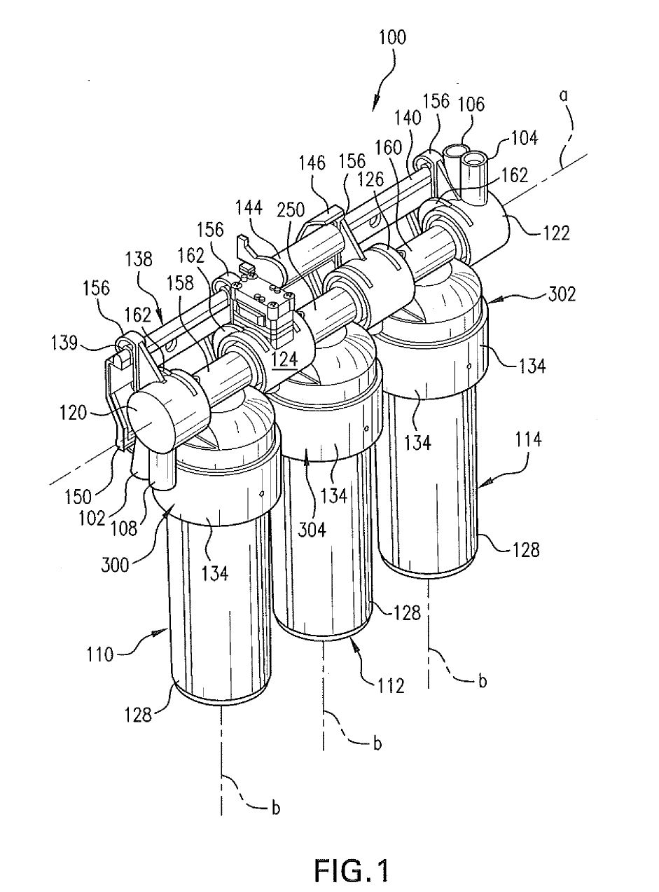

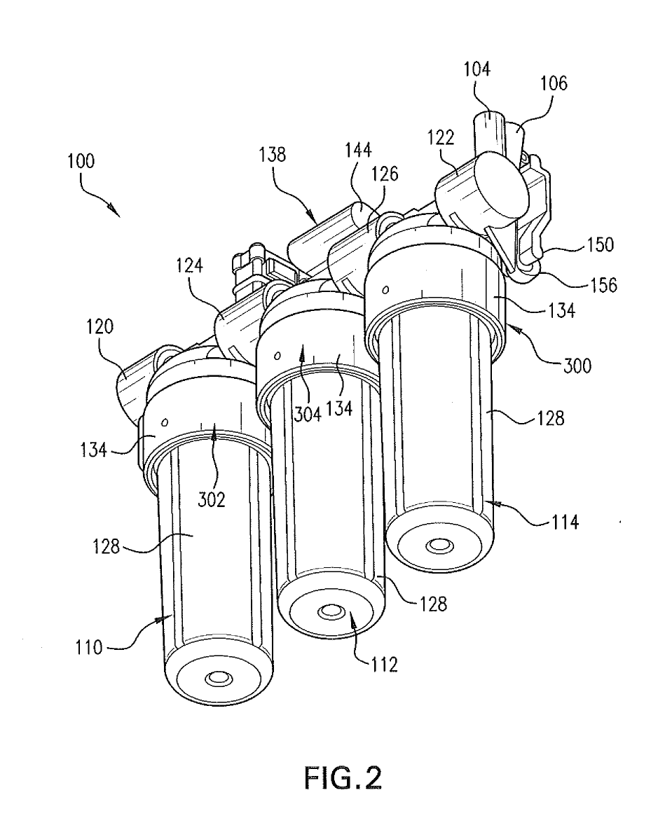

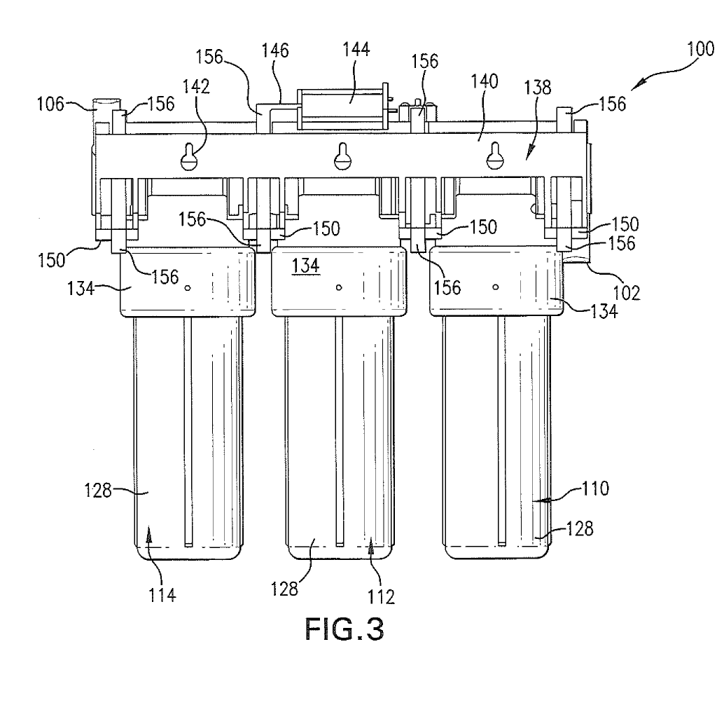

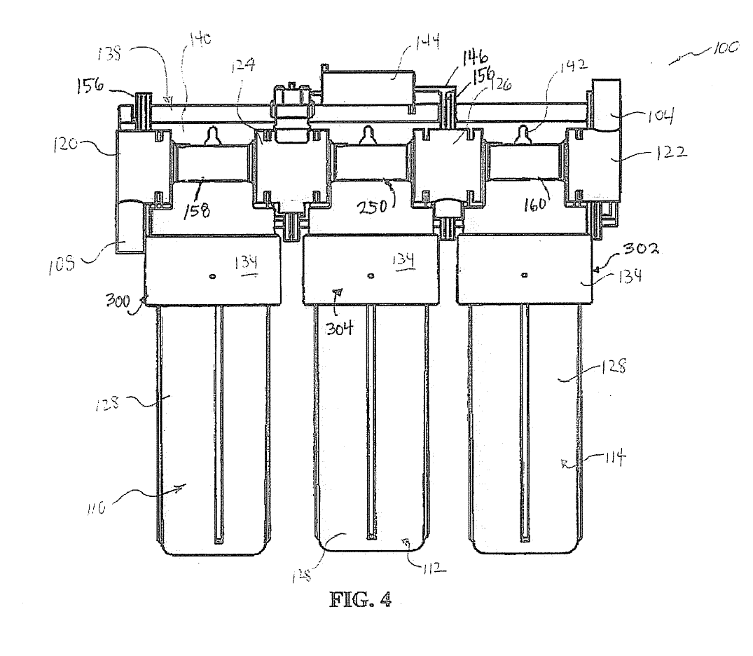

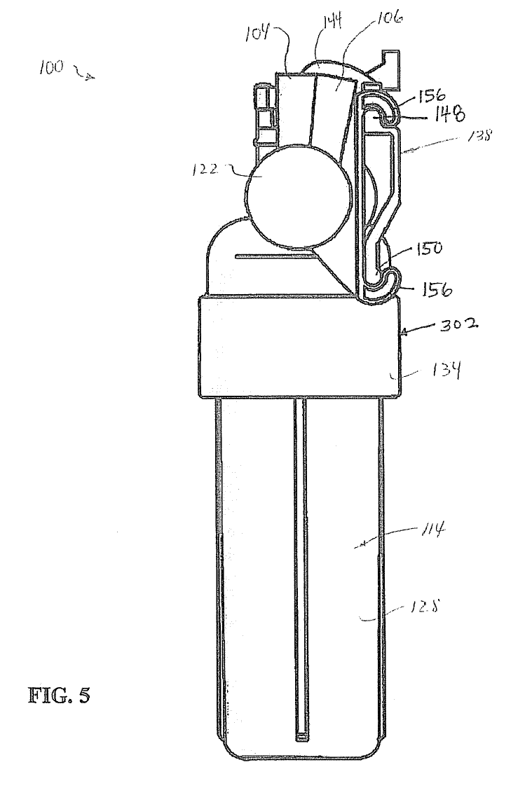

Referring to FIGS. 1-5, various perspective and plan views of exemplary embodiments of new and improved filter heads 300, 302, 304 and a RO water filter system 100 constructed in accordance with the present disclosure are shown. In brief overview, the intake water enters the filter system 100 from a water source by an inlet 102 and is routed there through. Typically, the intake water is municipal water or a similar unpurified source. The RO water filter system 100 generates purified water or permeate for dispensing from a faucet assembly (not shown). A faucet outlet 104 provides the permeate to the faucet assembly. The RO process also generates waste or concentrate water that is ultimately rejected to drain via a drain outlet 106. Additionally, permeate is created and stored in a storage tank (not shown), which is connected to a storage tank outlet 108.

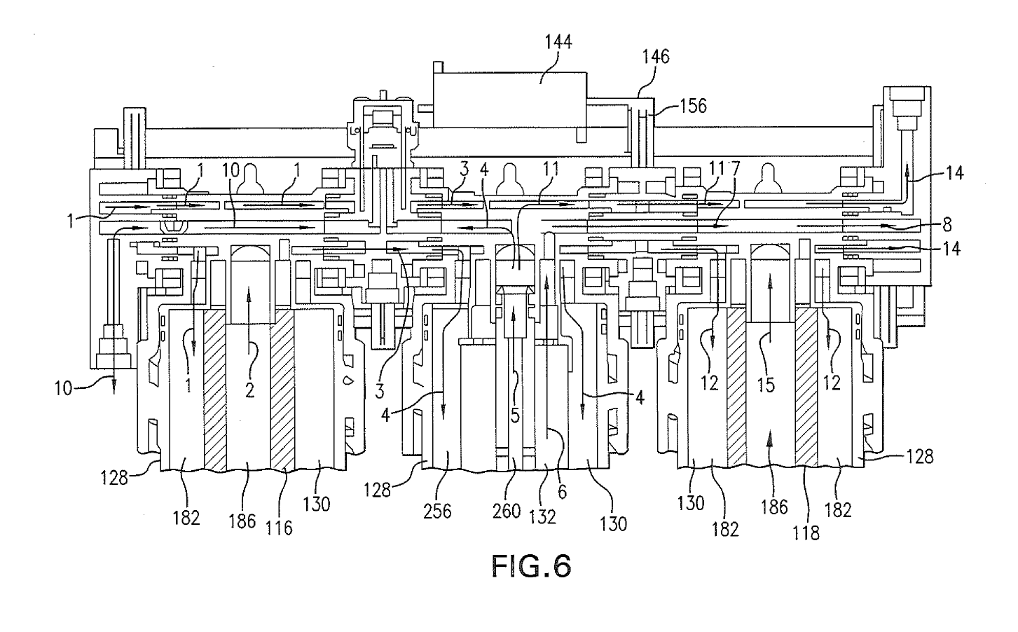

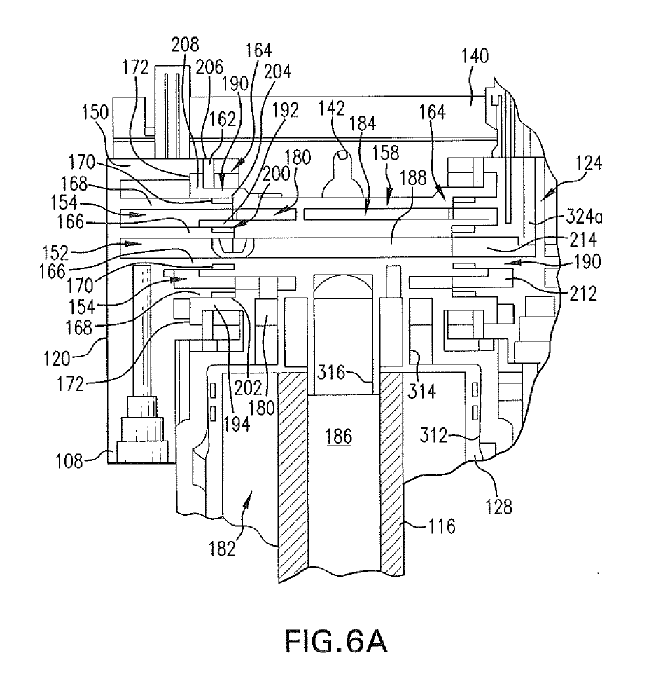

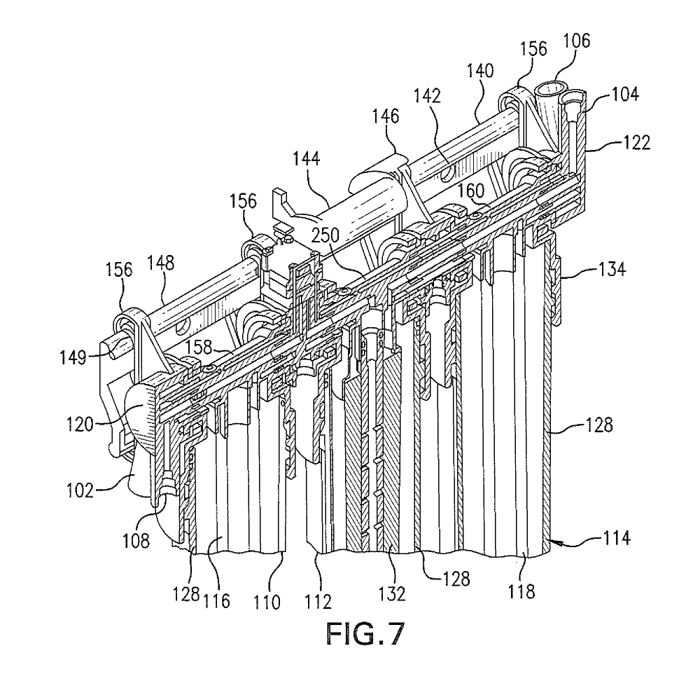

The system 100 includes a pre-RO filter assembly 110 for initially removing sediment and contaminants from the water supply. Referring additionally to FIGS. 6 and 7, the pre-RO filter assembly 110 can include a sediment filter 116. The pre-RO filter assembly 110 could also include a carbon filter or a combination sediment and carbon filter depending upon the application.

After passing through the pre-RO filter assembly 110, the filtered water passes into a RO filter assembly 112 containing an RO filter membrane 132 that creates permeate and concentrate water. The permeate is then further filtered by passing through a post-RO filter assembly 114 before passing to the faucet assembly. Similar to the pre-RO filter 116, the post-RO filter 118 may be any known filters such as a combination sediment and a carbon filter. End connectors 120, 122 and retaining connectors 124, 126 couple the filter assemblies 110, 112, 114 together. The connectors 120, 122, 124, 126 are somewhat similar such that similar elements have the same reference numerals.

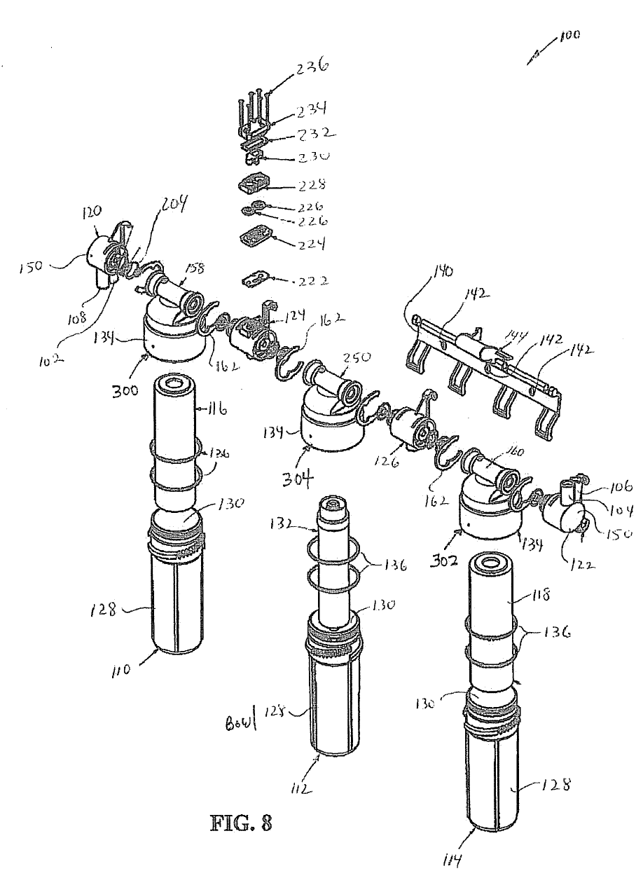

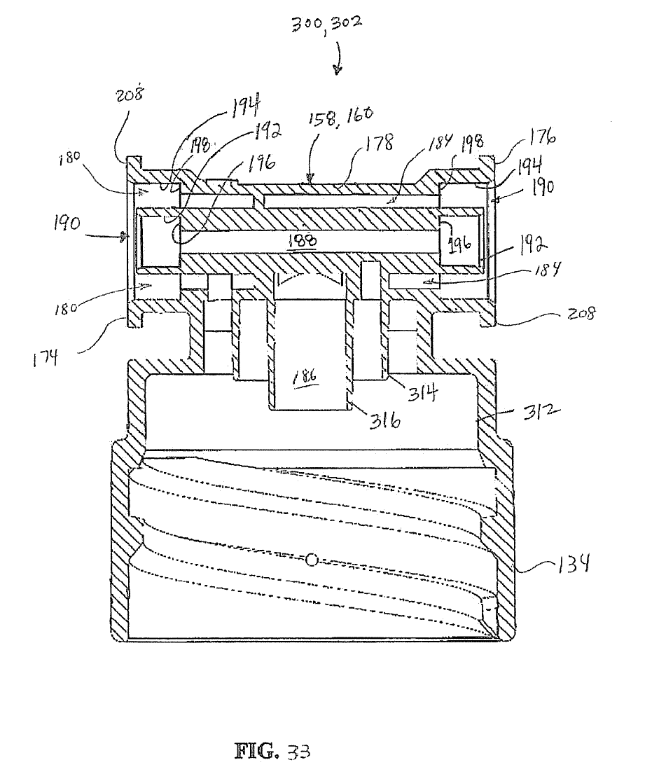

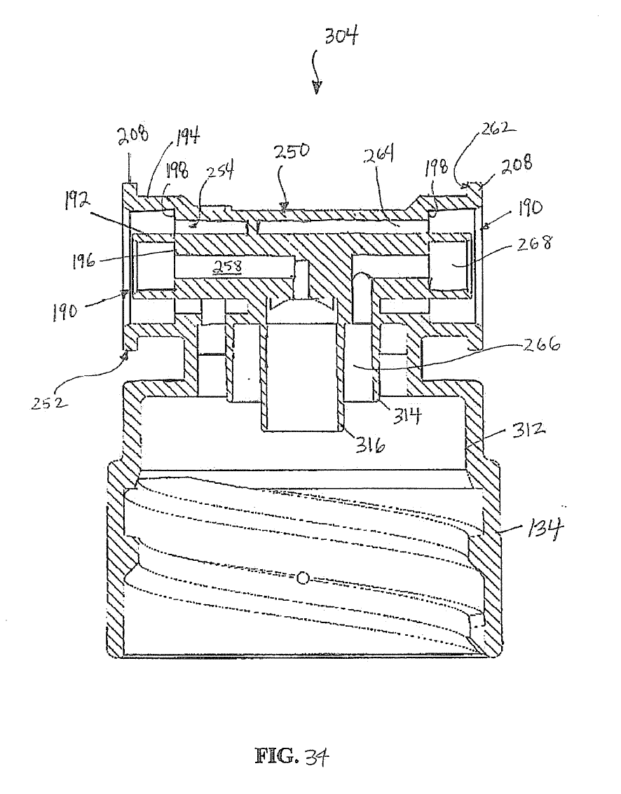

Referring now to FIG. 8, an exploded view of the system 100 is shown. Each filter assembly 110, 112, 114 includes a bowl 128 that defines an interior 130 within which the respective filter 116, 132, 118 is housed. The bowls 128 have threads for engaging lids 134 of the filter heads 300, 302, 304. Seals 136 help to make the coupling between the bowls 128 and the lids 134 fluid tight. As best shown in FIGS. 33 and 34, each of the lids 134 includes a filter bowl receptacle 312 positioned coaxially about a central axis “b”, a central receptacle 316 positioned coaxially within the filter bowl receptacle, and an intermediate receptacle 314 positioned coaxially between the filter bowl receptacle and the central receptacle.

The filter assemblies 110, 112, 114 attach to a mounting assembly 138 so that the system 100 may be easily fixed to a desired location. Each filter assembly 110, 112, 114 depends from the mounting assembly 138. The mounting assembly 138 allows for easy access and replacement of the filters 112, 118, 132. The mounting assembly 138 includes a bracket 140 with mounting holes 142 for securing the system 100 to a desired location. Each of the connectors 120, 122, 124, 126 includes locking features 156 that slide onto, and snap fit to, the mounting assembly bracket 140. In the exemplary embodiment shown, the locking features comprise spaced-apart hooks 156.

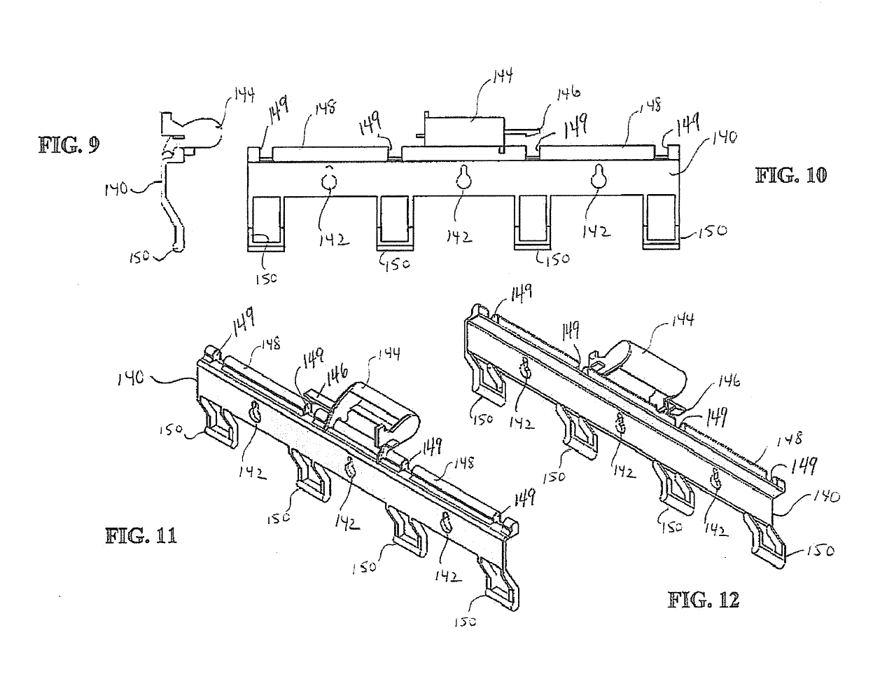

Referring to FIGS. 9-12, various perspective and plan views of the bracket 140 are shown. The bracket 140 includes a handle 144 that has a locking clip 146 that catches an upper hook 156 on the connector 126 for helping to retain the filter assemblies 110, 112, 114 thereto. The bracket 140 has an upper bar 148 defining recesses 149 for receiving the upper hooks 156 of the connectors 120, 122, 124, 126, and opposing four mounting portions or tabs 150 for receiving the lower hooks 156 of the connectors 120, 122, 124, 126.

Referring again to FIG. 8, the filter system 100 includes the first end connector 120 that defines the inlet 102 and storage tank outlet 108 extending from a body 150. The second end connector 122 defines the drain outlet 106 and faucet outlet 104 also extending from a body 150. In the exemplary embodiment shown, the end connectors 120, 122 are identical, interchangeable parts.

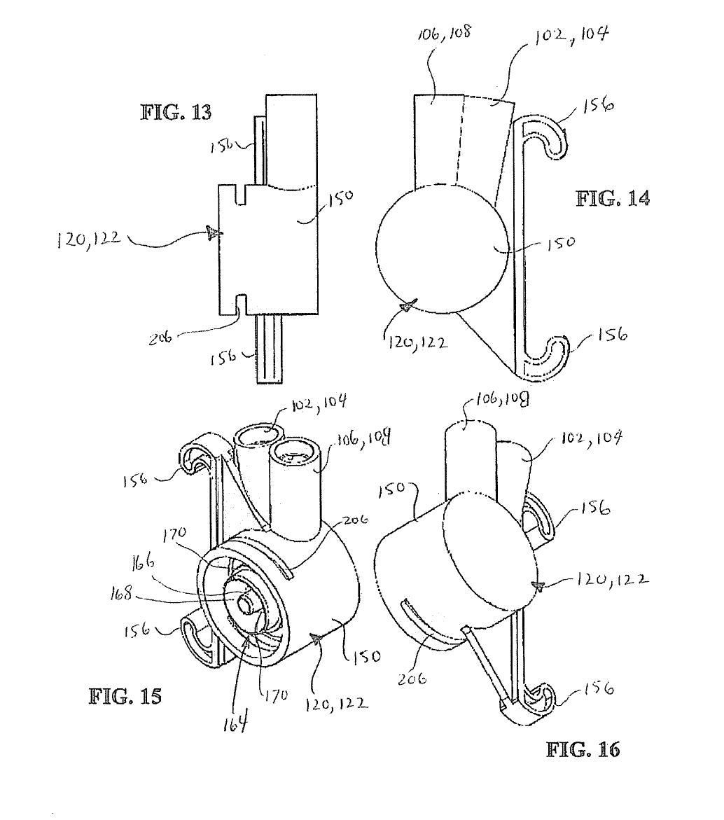

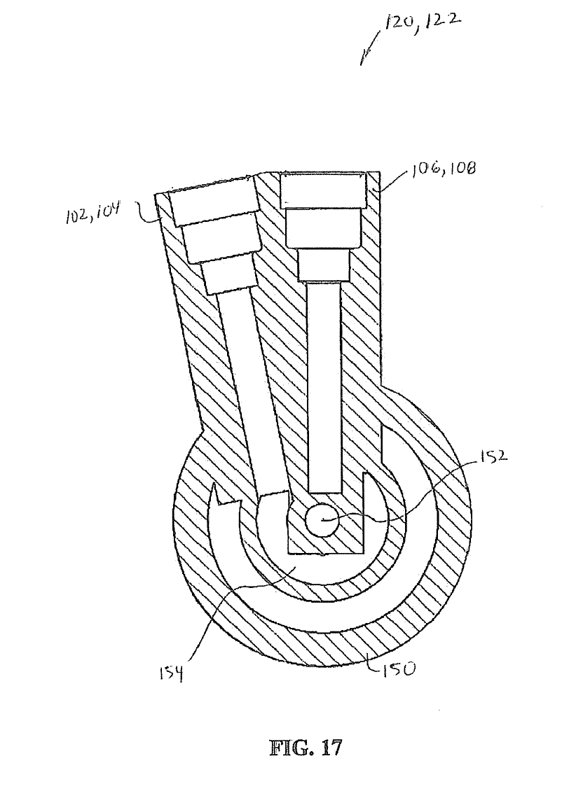

As best seen in the perspective and plan view of FIGS. 13-16 as well as the cross-sectional view of FIG. 17, the end connectors 120, 122 define axial pathways of an inner pathway 152 and an outer arcuate pathway 154. For the first end connector 120, the inner pathway 152 is in fluid communication with the storage tank outlet 108 and the outer arcuate pathway 154 is in fluid communication with the inlet 102. For the second end connector 122, the inner pathway 152 is in fluid communication with the drain outlet 106 and the outer arcuate pathway 154 is in fluid communication with the faucet outlet 104.

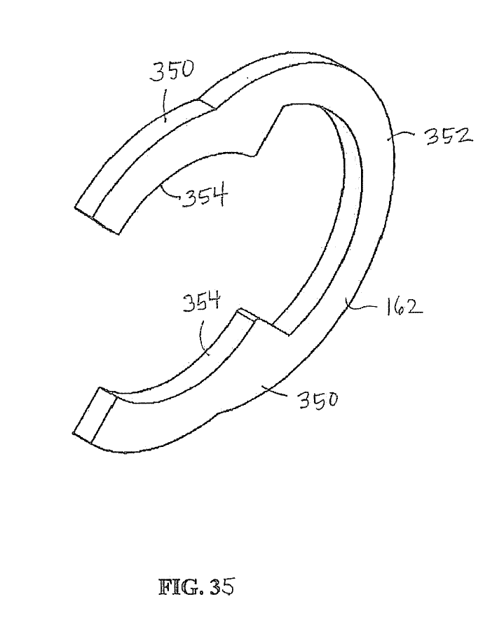

Referring again to FIG. 1, connector portions 158, 160 extend from each end connector 120, 122 and are adapted to couple to the lids 134 of the pre-RO filter assembly 110 and post-RO filter assembly 114, respectively. In the exemplary embodiment shown, the connector portions 158, 160 are identical, interchangeable parts. The connector portions 158, 160 are unitarily formed with the lids 134 as part of the filter heads 300, 302. Retainer clips 162, also shown in FIG. 35, secure the connector portions 158, 160 to the respective end connector 120, 122. The retainer clips 162 are resilient and form a recess to effectuate a snap fit that does not require tooling to engage. In the exemplary embodiment shown, the clips 162 are U-shaped and include two distal arms 350 extending from an intermediate portion 352. The intermediate portion 352 flexes to allow the arms 350 to spread apart as the clips 162 are inserted onto the connector portions 158, 160, and then resiliently snap back so that the arms 350 grip the connector portions 158, 160. The arms 350 include contoured surfaces 354 which match the circumference of the outer surface of the connector portions 158, 160.

Referring to FIGS. 6A and 15, the interfaces between the end connectors 120, 122 and connector portions 158, 160, and the interfaces between the connector portions 158, 160, 250 and the retaining connectors 124, 126, are designed to be fluid tight yet allow rotational movement of the filter assemblies 110, 112, 114. To accomplish the connection, each end connector 120, 122 and each retaining connector 124, 126 includes female sockets 164. Each female socket 164 includes a central tubular portion 166 that forms the inner pathway 152 and an outer tubular portion 168 that forms the outer pathway 154. The tubular portions 166, 168 are necked down such that each forms a shoulder 170. The body 150 also has a varying inner radius such that a shoulder 172 is also formed thereon.

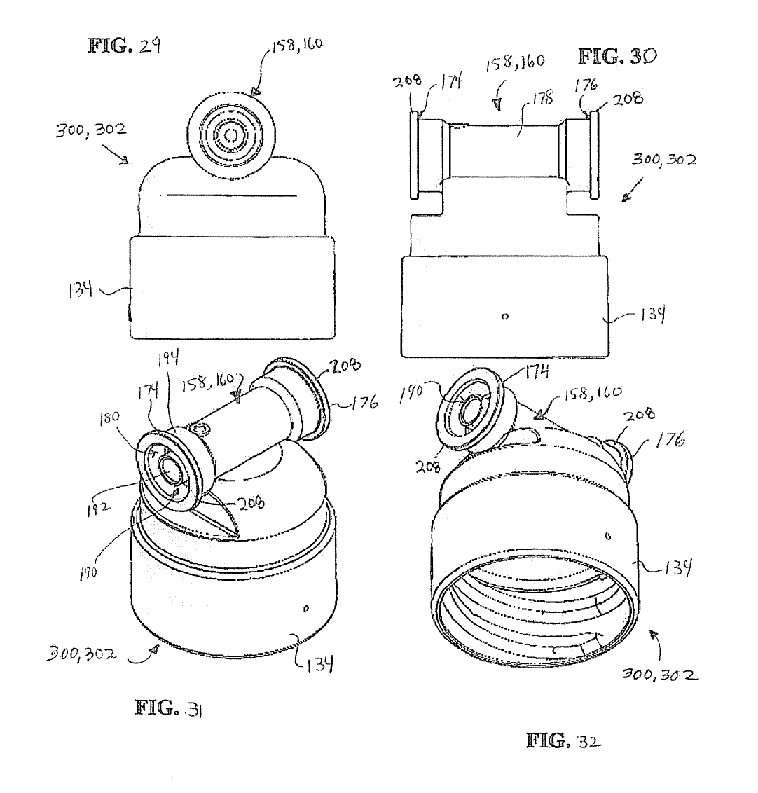

As best seen in the perspective and plan view of FIGS. 29-32 as well as the cross-sectional view of FIG. 33, each connector portion 158, 160 has a first side 174 and a second side 176 with a body 178 extending there between. The first side 174 defines an inlet conduit or pathway 180 in fluid communication with the filter bowl receptacle 312 and an outer portion 182 of the interior 130 of the respective bowl 128. The outer portion 182 being the area within the bowl 128 radially outside of the pre-RO filter 116, as shown in FIG. 6.

As best seen in FIGS. 6, 6A and 33, the second side 176 defines an outer pathway 184 in fluid communication with the central receptacle 316 and a central portion 186 of the interior 130 of the respective bowl 128. The central portion 186 being the area within the bowl 128 radially inside of the pre-RO filter 116.

The connector portions 158, 160 also define central axial pathways 188 that extend from the first side 174 to the second side 176. The central pathways 188 that extend along the axial length are in fluid communication with the inner pathways 152 of the end connectors 120, 122.

As seen in FIGS. 6A, 31 and 33, for example, to make a fluid tight connection with the end connectors 120, 122 and the retaining connectors 124, 126, the connector portions 158, 160, 250 include male sockets 190 that couple to the female sockets 164 of the end connectors 120, 122 and the retaining connectors 124, 126. Each male socket 190 includes a central tubular portion 192 and an outer tubular portion 194. The tubular portions 192, 194 have ends with relatively larger inner radii 196, 198. Each of the connector portions 158, 160, 250 also includes end flanges 208.

Referring now to FIG. 6A, a detailed cross-sectional view of the coupling between the first end connector 120 and the connector portion 158 is shown. The male socket 190 is inserted in the female socket 164 such that the connector portion flange 208 abuts the first end connector shoulder 172. The respective central tubular portions 166, 192 and outer tubular portions 168, 194 are aligned to complete the fluid pathways there through. The necked down shoulders 170 and larger inner radii 196, 198 couple to form annular cavities 200, 202 in which at least one seal 204 resides.

Each of the end connectors 120, 122 and the retaining connectors 124, 126, include slots 206. The retainer clips 162 are inserted in the slots 206 and capture the flanges 208 so that the male sockets 190 are firmly and securely seated within the female sockets 164. Hence, fluid tight seals are created and maintained even though the connector portions 158, 160, 250 may be rotated upwards about the axis “a” with respect to the first end connector 120.

It should be noted that in an alternative embodiment of the present disclosure, the end connectors 120, 122 and the retaining connectors 124, 126 can be provided with the male sockets 190 and the connector portions 158, 160, 250 can be provided with the female sockets 164.

Referring again to FIG. 1, the first retaining connector 124 couples to the second side 176 of the connector portion 158 and snaps onto the mounting assembly bracket 140. Another retainer clip 162 also secures the connector portion 158 and the first retaining connector 124 together. The first end connector 120 and first retaining connector 124 together effectively couple to the mounting assembly bracket 140 such that the connector portion 158, and thereby the filter head 300 and the pre-RO filter assembly 110, may selectively rotate upwards about the axis “a” to facilitate bowl removal and filter replacement.

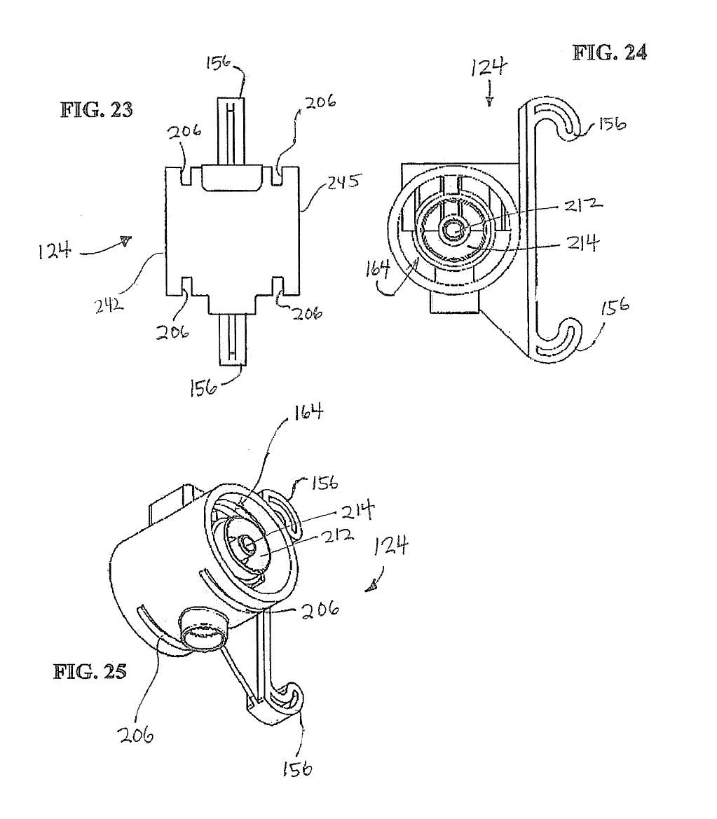

As best seen in the perspective and plan views of FIGS. 23-26 as well as the cross-sectional view of FIG. 27, the first retaining connector 124 defines an outer pathway 212 in fluid communication with the outer pathway 184 of the second side 176 of the connector portion 158. The first retaining connector 124 also defines a central pathway 214 in fluid communication with the central pathway 188 of the connector portion 158.

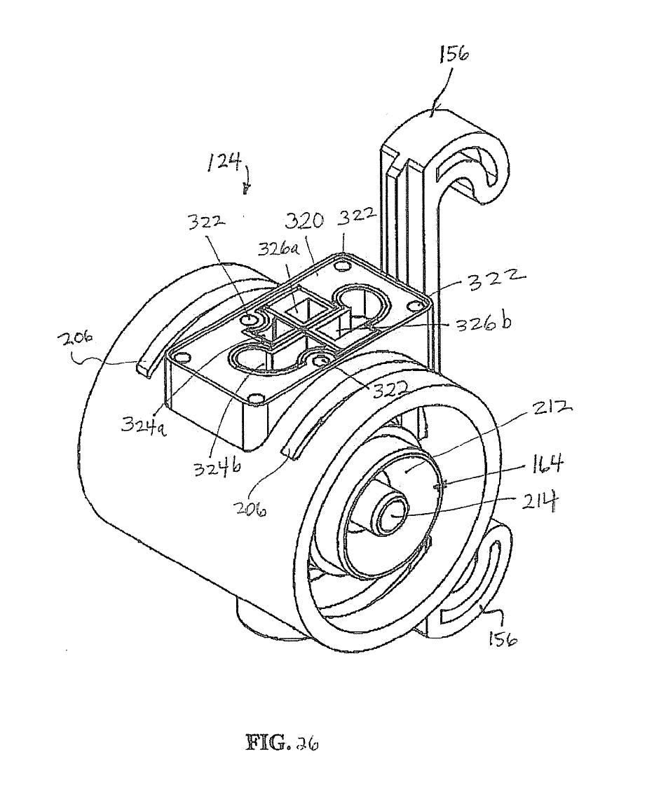

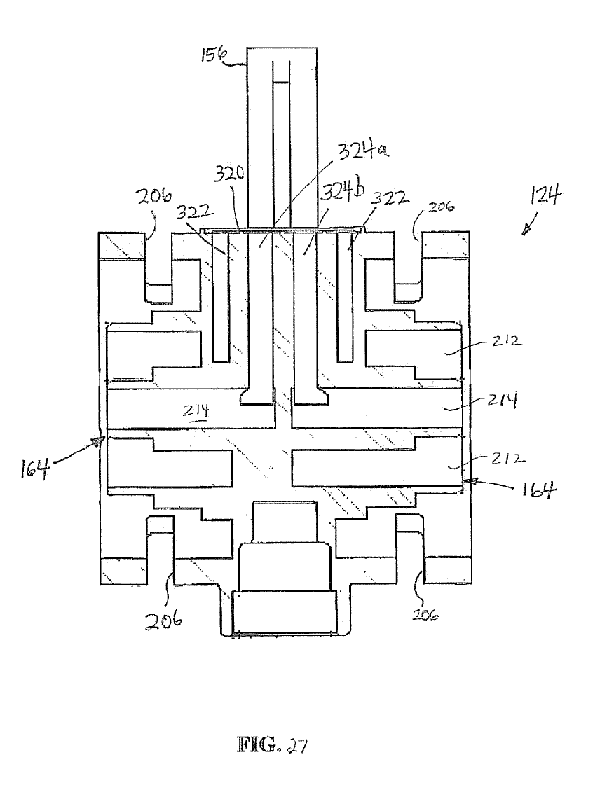

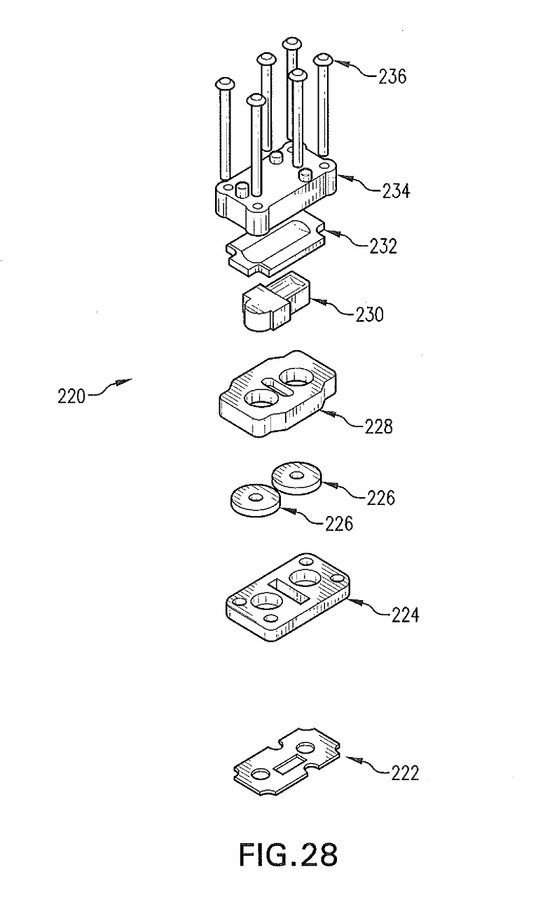

Referring to FIG. 1 again, the first retaining connector 124 also includes a shut-off valve assembly 220. Within the first retaining connector 124, the central pathway 214 turns upward through the shut-off valve assembly 220. The shut-off valve assembly 220 serves to close off flow into the system 100 when the storage tank is full. However, when the storage tank drops in pressure, i.e., is partially empty, the shut-off valve assembly 220 opens to allow tap water into the system 100 for additional creation of permeate. Referring to FIG. 28, an exploded view of the shut-off valve assembly 220 is shown. The shut-off valve assembly 220 is integral to the retaining connector 124, which includes a gasket 222, a spacer 224, diaphragms 226, a cap 228, a piston 230, a gasket 232, and a cover 234 that are retained by screws 236. As shown in FIGS. 26 and 27, the first retaining connector 124 includes a raised platform 320 having screw holes 322 for receiving the shut-off valve assembly 220, passages 324a, 324b connected to the central pathway 214, and passages 326a, 326b connected to the outer pathway 212. When the storage tank is full, pressure rises in the central pathway 214 and the higher pressure is transmitted via passages 324a, 324b to shut-off valve assembly 220, which blocks flow between passages 324a, 324b and stops flow in outer pathway 212.

Referring again to FIGS. 1 and 6, the connector portion 250 extends from the first retaining connector 124 and is unitarily formed with the lid 134 to form the filter head 304 of the RO filter assembly 112. Although outwardly similar in appearance to the connector portions 158, 160, the middle connector portion 250 is different as best seen by the cross-sectional view of FIG. 34.

On a first side 252, the connector portion 250 defines a first pathway 254 in fluid communication with the filter bowl receptacle 312 and an outer portion 256 of the interior 130 of the filter bowl 128, as shown in FIG. 6. However, a second pathway 258 on the first side 252 is in fluid communication with the central receptacle 316 and a central portion 260 of the RO filter 132 so that permeate may flow there through. On a second side 262 of the connector portion 250, a third pathway 264 is also in fluid communication with the central receptacle 316 and the central portion 260 of the RO filter 132 so that permeate may flow there through. As the RO filter 132 also defines a waste flowpath, the connector portion 250 has an intermediate collection area 266 that is in fluid communication with the intermediate receptacle 314 and a fourth pathway 268 on the second side 262. In the exemplary embodiment shown the first pathway 254 and the third pathway 264 are coaxially position outside of the second pathway 258 and the fourth pathway 268.

Referring again to FIG. 1, the second retaining connector 126 extends from the connector portion 250 and also couples onto the mounting assembly bracket 140. The connector portion 250 and second retaining connector 126 couple to the mounting assembly bracket 140 such that the connector portion 250, and thereby the RO filter assembly 112, may selectively rotate upwards about the axis “a” to facilitate bowl removal and filter replacement. A retainer clip 162 also secures the connector portion 250 and the second retaining connector 126 together.

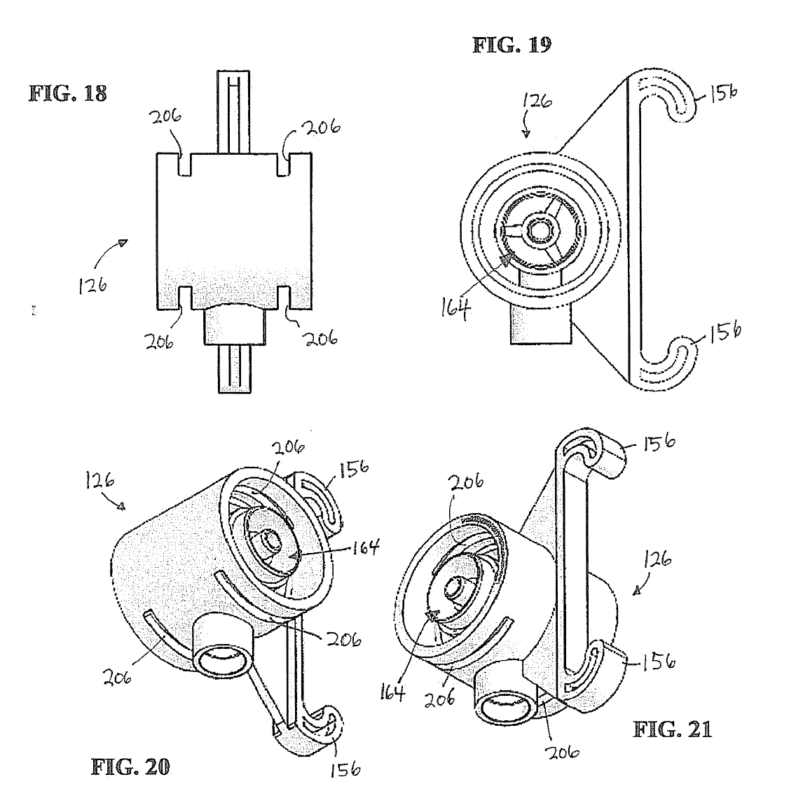

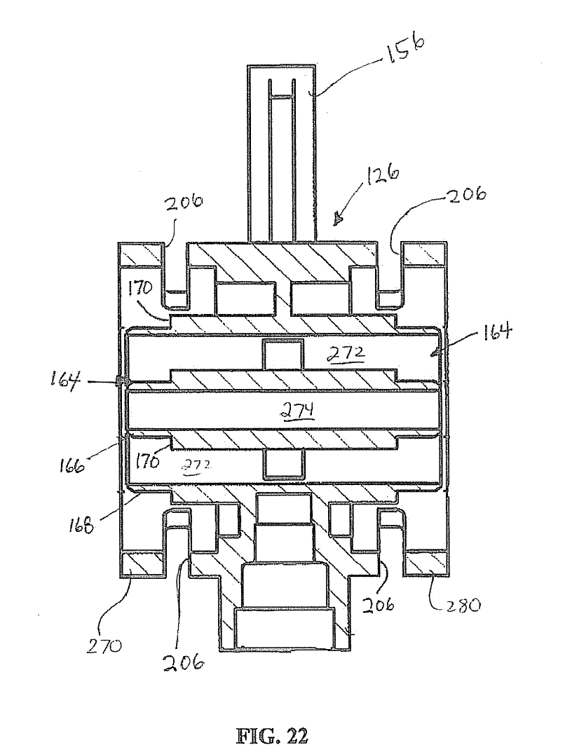

As best seen in the perspective and plan view of FIGS. 18-21 as well as the cross-sectional view of FIG. 22, a first side 270 of the second retaining connector 126 defines an outer pathway 272 in fluid communication with the outer pathway 264 on the second side 262 of the connector portion 250. The second retaining connector 126 also defines a central pathway 274 in fluid communication with the central pathway 268 on the second side 262 of the connector portion 250.

Referring again to FIG. 1, a second side 280 of the second retaining connector 126 couples to a first side 174 of the connector portion 160. A second side 176 of the connector portion 160 couples to the second end connector 122. Again, a retaining clip 162 secures into the slots 206 of the second end connector 122 to maintain the coupling to the second side 176 of the connector portion 160.

### Operation

As can be seen from the discussion above, fluid tight seals are created between the components such that the inlet 102, storage tank outlet 108, drain outlet 106, and faucet outlet 104 interconnect via various pathways into and out of the filter assemblies 110, 112, 114. The end connectors 120, 122 and retaining connectors 124, 126 couple to the mounting assembly bracket 140 such that the connector portions 158, 160, 250, and thereby the filter assemblies 110, 112, 114 may selectively rotate upwards about the axis “a” to facilitate bowl removal and filter replacement.

Referring now to FIGS. 6-8, a cross-sectional view of the filter system 100 is shown with flow arrows to help illustrate fluid flow through the system 10. The filter system 100 defines a plurality of flowpaths or conduits that extend across from the first end connector 120 to the second end connector 122 through the connector portions 158, 160, 250, retaining connectors 124, 126, lids 134, bowls 128 and filters 112, 118, 132. The first end connector 120, the second end connector 122, the connector portions 158, 160, 250, and retaining connectors 124, 126 generally form a line along the axis “a”.

The lids 134 and filter bowls 128 are positioned coaxially parallel axis “b”, which is substantially perpendicular to axis “a”. The filters 112, 118, 132 are also positioned coaxially within the bowls 128.

In operation, the tap water enters the inlet 102, flows through the outer annular pathway 154 of the first end connector 120 into the inlet pathway 180 of the connector portion 158, and enters the outer portion 182 of the bowl 128 of the pre-RO filter assembly 110 as shown by arrows “1”. Once in the interior 130 of the pre-RO filter assembly 110, the tap water washes through the sediment filter 116 to become filtered tap water. The filtered tap water collects in the central portion 186 of the bowl 128 within the sediment filter 116 and flows upward into the outer pathway 184 of the second side 176 of the connector portion 158 as shown by arrows “2”.

The filtered tap water passes into and through the outer annular pathway 212 of the first retaining connector 124 to enter the outer inlet pathway 254 on the first side 252 of the connector portion 250 of the RO filter assembly 112 as shown by arrows “3”. The filtered tap waters flows downward into the outer portion 256 of the bowl 128 of the RO filter assembly 112 as shown by arrows “4”. By washing through the RO filter 132, the filtered tap water becomes permeate and concentrate. The permeate flows upward out of the RO filter 132 as shown by arrow “5” and the concentrate flows upward out of the RO filter 132 as shown by arrow 6.

The concentrate passes into the intermediate collection area 266 and out the central pathway 268 of the second side 262 of the connector portion 250 to enter and pass through the central pathway 274 of the retaining connector 126 as shown by arrow “7”. The concentrate also passes through the central pathway of the connector portion 158 into the central pathway 152 of the second end connector 122 as shown by arrow “8” to ultimately pass to drain via the drain outlet 106.

The permeate generated in the RO filter 132 passes upward into the outer pathway 264 on the second side 262 of the connector portion 250 and into the central pathway 258 on the first side 252 as shown by arrows “9”.

When the faucet is closed, the permeate will mainly flow through the central pathway 258 to ultimately accumulate in the storage tank noting that the storage tank is present to augment supply beyond what the RO filter 132 can actively produce. To fill the storage tank, the permeate passes into the central pathway 214 of the retaining connector 124 and through the shut-off valve assembly 220. When the storage tank is not full, the resulting pressure drop opens the shut-off valve assembly 220 to allow the permeate to pass thereto as noted by arrows “10”. As noted by the double arrowheads, arrows “10” indicate that flow may proceed in either direction depending upon the circumstances. Upon the storage tank becoming full, the pressure equalizes to close the shut-off valve assembly 220 and prevent further permeate flow.

When the faucet opens, the permeate flows directly from the RO filter 132 along arrow “5” into the outer pathway 264 on the second side 262 of the connector portion 250 and into the outer pathway 272 of the second retaining connector 126 to pass to the outer pathway 184 of the connector portion 160 as shown by arrows “11”.

From the connector portion 160, the permeate enters the outer portion 182 of the bowl 128 of the post-RU filter assembly 114 as shown by arrows “12”. Once in the interior 130 of the post-RU filter assembly 114, the permeate washes radially inward through the second sediment filter 118 to become filtered permeate. The filtered permeate collects centrally within the second sediment filter 118 and flows upward into the outer pathway 184 of the connector portion 160 as shown by arrows “13”.

The filtered permeate passes through the outer pathway 184 of the second side 176 of the connector portion 160 and enters the outer pathway 154 of the second end connector 122 as shown by arrows “14”. The filtered permeate passes out the faucet via the faucet outlet 104. If the demand exceeds the amount of filtered permeate generated by the assembly 100, the pressure drops in the permeate flowpath such that the shut-off valve assembly 220 opens to allow pressurized permeate to flow from the storage tank. The storage tank permeate supplements the permeate generated by the RO filter assembly 112 so that a maximum flow of filtered permeate through the post-RO filter assembly 114 may occur during high demand.

### Maintenance

In order to change any of the filters 112, 118, 132, the tap water supply is closed. Then, one utilizes the ability of the male and female sockets forming junctions that can rotate about the axis “a”. For example, if the RO filter 132 needs to be changed, the bowl 128 may be rotated upward about axis “a” because the male sockets 190 of the connector portion 250 may rotate within the respective female sockets 164. Once rotated upward, the bowl 128 may be unscrewed from lid 134 for easy RO filter replacement. Once replaced, the bowl 128 is screwed back into the lid 134. The bowl 128 rotates back to the original position and the tap water supply is reopened. Similar procedures are followed for replacing the other filters 116,118.

In view of the above, the present disclosure provides new and improved RO filtering systems. It should be understood, however, that the exemplary embodiments described in this specification have been presented by way of illustration rather than limitation, and various modifications, such as larger number of filters strung together with similar components, combinations and substitutions may be effected by those skilled in the art without departure either in spirit or scope from this disclosure in its broader aspects.

What is claimed is:

1. A filter head comprising:
(a) a lid extending along a central axis and including,
a filter bowl receptacle positioned coaxially about the central axis,
a central receptacle positioned coaxially within the filter bowl receptacle, and
an intermediate receptacle positioned coaxially between the filter bowl receptacle and the central receptacle; and
(b) a conduit portion connected to the lid and extending between a first end and a second end along a central axis that is normal to the central axis of the lid, and including,
a first pathway extending between the first end and the filter bowl receptacle,
a second pathway extending between the first end and the central receptacle,
a third pathway extending between the second end and the central receptacle, and
a fourth pathway extending between the second end and the intermediate receptacle,
wherein the first and second ends of the conduit portion are adapted to receive couplings such that the filter head can be pivoted about the axis of the conduit portion.

2. A filter head according to claim 1 wherein,
the second and the fourth pathways are aligned with the axis of the conduit portion,
the first pathway is positioned coaxially about the second pathway, and
the third pathway is positioned coaxially about the fourth pathway.

3. A filter head according to claim 2 wherein the first and second ends include male sockets having:
an inner tubular portion aligned with the axis of the conduit portion and connected to the second and fourth pathways respectively, and
an outer tubular portion positioned coaxially about the inner tubular portion and connected to the first and third pathways respectively.

4. An elongated mounting assembly for a liquid filter system comprising:
a first end connector defining a first pathway in fluid communication with a storage tank outlet for connection to a storage tank and a second pathway in fluid communication with an inlet for connection to a water source;
a second end connector defining a first pathway in fluid communication with a drain outlet for waste and a second end connector defining a second pathway in fluid communication with an outlet for connection to a faucet assembly;
a connector portion extending between the end connectors; and
a RO filter assembly that creates permeate and concentrate water depending from the connector portion, the RO filter assembly having a bowl that defines an interior having an inlet area, an intermediate area, and an outlet area and a RO filter within the interior between the inlet area and the outlet area;
wherein the connector portion has:
(i) a first side defining a first pathway in fluid communication with the first pathway of the first end connector and the outlet area of the interior so that permeate may flow there through; and a second pathway in fluid communication with the second pathway of the first end connector and the inlet area of the interior; and
(ii) a second side defining a first flowpath in fluid communication with the first pathway of the second end connector and the intermediate area for receiving concentrate and a second pathway in fluid communication with the second pathway of the second end connector and the outlet area of the RO filter so that permeate may flow there through,
each end connector has body defining a female socket having a first tubular portion that forms the first pathway and a second tubular portion that forms the second pathway, and
each side of the connector portion has a body defining a male socket having a first tubular portion that forms the first pathway and a second tubular portion that forms the second pathway.

5. An elongated mounting assembly as recited in claim 4, wherein the first end connector's female socket couples with the first side's male socket and the second end connector's female socket couples with the second side's male socket in fluid tight manners while allowing rotation of the RO filter assembly.

6. An elongated mounting assembly as recited in claim 4, wherein the body of the end connectors surrounding the tubular portions has a varying inner radius such that a shoulder is also formed thereon, wherein the first tubular portion is radially within the second tubular portion.

7. An elongated mounting assembly as recited in claim 4, wherein the body of the connector portion forms a flange on each side that surrounds the second tubular portion and the first tubular portion is radially inside the second tubular portion.

8. An elongated mounting assembly as recited in claim 4, wherein each tubular portion is necked down to form a shoulder and each tubular portion has ends with relatively larger inner radii such that the necked down shoulders and larger inner radii couple to form annular cavities in which at least one seal resides.

9. An elongated mounting assembly as recited in claim 8, further comprising at least one additional connector portion coupled to one of the end connectors and at least one additional non-RO filter assembly having a bowl that defines an interior having an inlet area and an outlet area and a non-RO filter within the interior between the inlet area and the outlet area.

10. An elongated mounting assembly as recited in claim 9, wherein the at least one additional connector portion has: (i) a first side defining a first pathway and a second pathway in fluid communication with the outlet area of the non-RO filter assembly's interior; and (ii) a second side defining a first flowpath in fluid communication with the first pathway of the at least one additional connector portion's first side and the inlet area of the non-RO filter assembly's interior, and
each side of the at least one additional connector portion has a male socket including a body having a first tubular portion that forms the first pathway and a second tubular portion that forms the second pathway, each tubular portion having ends with relatively larger inner radii, and
further comprising at least one retaining connector having a locking feature for engaging a mounting bracket and for coupling the connector portions together and such that the connector portions may selectively rotate about an axial axis to facilitate bowl removal and filter replacement,
wherein the at least one retaining connector portion has: (i) a first side defining a first pathway and a second pathway; and (ii) a second side defining a first pathway in fluid communication with the first pathway of the at least one retaining connector portion's first side, and a second pathway in fluid communication with the second pathway of the at least one retaining connector portion's first side.

11. An elongated mounting assembly as recited in claim 4, further comprising at least one retaining clip to secure the male and female sockets together.

12. An elongated mounting assembly as recited in claim 4, wherein the at least one retaining connector includes a shut-off valve assembly in fluid communication with the first pathway thereof.

13. An elongated mounting assembly as recited in claim 4, wherein when the male socket is inserted in the female socket,
the flange abuts the first end connector shoulder,
the respective first tubular portions and second tubular portions are aligned to complete the fluid pathways there through, and
a retainer clip is inserted in a slot formed in the end connector to apply a compressive force so that the male socket is firmly and securely seated within the female socket and fluid tight seals are created and maintained even though the connector portion may be rotated upwards about the axis with respect to the first end connector.

14. An elongated mounting assembly as recited in claim 4, further comprising a third connector portion with a non-RO filter assembly and a second retaining connector coupling together connector portions.

15. An elongated mounting assembly as recited in claim 4, wherein the mounting assembly includes a bracket with mounting holes, the bracket has an upper bar opposing four mounting portions for coupling with locking features on the end connectors and retaining connectors.

16. An elongated mounting assembly as recited in claim 4, wherein the end connectors have a locking feature to snap fit onto a bracket of the mounting assembly.

17. A filter system comprising:
a filter head including,
(a) a lid extending along a central axis and including,
a filter bowl receptacle positioned coaxially about the central axis,
a central receptacle positioned coaxially within the filter bowl receptacle, and
an intermediate receptacle positioned coaxially between the filter bowl receptacle and the central receptacle, and
(b) a conduit portion connected to the lid and extending between a first end and a second end along a central axis that is normal to the central axis of the lid, and including,
a first pathway extending between the first end and the filter bowl receptacle,
a second pathway extending between the first end and the central receptacle,
a third pathway extending between the second end and the central receptacle, and
a fourth pathway extending between the second end and the intermediate receptacle,
wherein ends of the conduit portion include sockets; and
connectors positioned on either end of the conduit portion and including,
locking features for securing the connectors to a mounting assembly bracket, and
sockets receiving the sockets of the conduit portion such that the filter head is rotatable about the axis of the conduit portion.

18. A filter head according to claim 17 wherein the sockets of the filter head are male sockets and the sockets of the connectors are female connectors.

19. A filter head according to claim 17 wherein,
the second and the fourth pathways are aligned with the axis of the conduit portion,
the first pathway is positioned coaxially about the second pathway, and
the third pathway is positioned coaxially about the fourth pathway.

20. A filter head according to claim 19 wherein the sockets of the filter head include:
an inner tubular portion aligned with the axis of the conduit portion and connected to the second and fourth pathways respectively, and
an outer tubular portion positioned coaxially about the inner tubular portion and connected to the first and third pathways respectively.
